(19) United States
(12) Patent Application Publication
(10) Pub. No.: US 2025/0354886 A1
(43) Pub. Date: Nov. 20, 2025

(54) LIQUID DETECTION SENSOR

(71) Applicant: Proterial, Ltd., Tokyo (JP)

(72) Inventor: Hiroki SHIMIZU, Tokyo (JP)

(73) Assignee: Proterial, Ltd., Tokyo (JP)

(21) Appl. No.: 19/192,761

(22) Filed: Apr. 29, 2025

(30) Foreign Application Priority Data
May 16, 2024 (JP) 2024-080139

(51) Int. Cl. G01M 3/16

(52) U.S. Cl. CPC G01M 3/16

(57) ABSTRACT

A liquid detection sensor for detecting liquid ingress into a housing of a detection target device in which the housing is waterproofed, having an electrode configured to be inserted into a through-hole formed in the housing, and the liquid ingress into the housing is detected by a change in electrostatic capacitance of the electrode.

### CROSS-REFERENCE TO RELATED APPLICATIONS

The present patent application claims the priority of Japanese patent application No. 2024-080139 filed on May 16, 2024, the entire contents of which are incorporated herein by reference.

### TECHNICAL FIELD

This invention relates to a liquid detection sensor for detecting liquid ingress into a housing of a detection target device in which the housing is waterproofed.

### BACKGROUND OF THE INVENTION

Conventionally, for example, some vehicle steering devices are equipped with a sensor that detects moisture ingress into a housing (refer to Patent Literature 1 as an example).

The steering system described by Patent Literature 1 comprises a cylindrical housing, a steering rod supported through the housing in a vehicle width direction, a steering motor that moves the steering rod forward and backward, tie rods connected to both ends of the steering rod via ball joints, and boots covering openings of the housing. A sheet-type water droplet sensor having a pair of electrodes is disposed at each of the left and right ends of the housing. When moisture enters the housing and water droplets adhere to a surface of the water droplet sensor, the electrical resistance between the pair of electrodes of the water droplet sensor decreases, thereby detecting moisture ingress. When the moisture ingress is detected, the electronic control unit that controls the steering motor stops the operation of the steering motor to prevent the steering motor and other components from failing due to a short circuit.

### CITATION LIST

Patent Literature 1: JP2006-111032A

### SUMMARY OF THE INVENTION

In the sensor described by Patent Literature 1, for example, if a foreign matter such as dust or sand that has entered through a broken boot or grease inside the housing adheres to the electrode of the water droplet sensor, moisture ingress into the housing may not be detected. Therefore, the object of the present invention is to provide a liquid detection sensor capable of detecting with high reliability liquid ingress into a housing of a detection target device.

In order to achieve the above object, the present invention provides a liquid detection sensor for detecting liquid ingress into a housing of a detection target device having a waterproof housing, comprising an electrode configured to be inserted into a through-hole formed in the housing, wherein the liquid ingress into the housing is detected by a change in electrostatic capacitance of the electrode.

### Advantageous Effects of the Invention

According to the present invention, it is possible to provide a liquid detection sensor capable of detecting with high reliability liquid ingress into a housing of a detection target device.

### BRIEF DESCRIPTION OF THE DRAWINGS

FIG. 1 is a schematic diagram showing an example of a rough configuration of a vehicle steering device equipped with a liquid detection sensor 2 in an embodiment of the present invention.

FIG. 2 is a perspective view showing the liquid detection sensor together with a part of a rack housing.

FIG. 3 is a perspective view of the liquid detection sensor and a part of the rack housing, viewed from a different direction from FIG. 1.

FIG. 4 is an exploded perspective view of the liquid detection sensor, viewed from the same direction as FIG. 2.

FIG. 5 is an exploded perspective view of the liquid detection sensor, viewed from the same direction as FIG. 3.

FIG. 6 is a cross-sectional view of the liquid detection sensor and the rack housing.

FIG. 7A is a perspective cross-sectional view showing the liquid detection sensor partially enlarged.

FIG. 7B is a perspective view showing an electrode member of the liquid detection sensor.

FIG. 8 is a plane view of a substrate of the liquid detection sensor.

FIG. 9A is a configuration diagram showing the inside of a first member of a cable holder.

FIG. 9B is a configuration diagram showing the outside of the first member of the cable holder.

FIG. 10 is a plane view illustrating the substrate of the liquid detection sensor.

FIG. 11A is a cross-sectional view of the periphery of the electrode when there is no moisture ingress into the rack housing.

FIG. 11B is a cross-sectional view of the periphery of the electrode when water has entered the rack housing and accumulated in the periphery of the electrode.

### MODE FOR CARRYING OUT THE INVENTION

### Embodiment

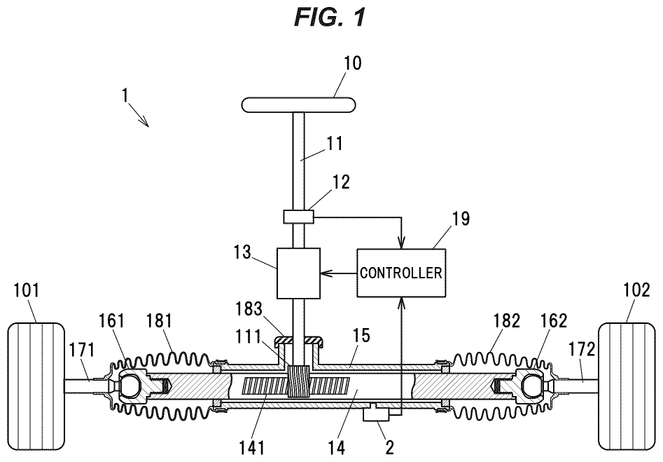

FIG. 1 is a schematic diagram showing an example of a rough configuration of a vehicle steering device 1 equipped with a liquid detection sensor 2 according to an embodiment of the present invention.

The steering device 1 comprises a steering wheel 10 operated by the driver, a steering shaft 11 connected to the steering wheel 10, a torque sensor 12 that detects steering torque transmitted from the steering wheel 10 to the steering shaft 11, a steering assist device 13 that assists steering operation, a cylindrical rack shaft 14 extending in the right and left directions of the vehicle, a rack housing 15 that houses the rack shaft 14, and a pair of ball joints 161, 162 connected to both ends of the rack shaft 14, a pair of right and left tie rods 171, 172 pivotably connected to the rack shaft 14 via the ball joints 161, 162, bellows boots 181, 182 that are disposed between the ends of the rack shaft 14 and the pair of right and left tie rods 171, 172 respectively, a sealing member 183 covering an opening of the rack housing 15 into which the steering shaft 11 is inserted, and a controller 19 that controls the steering assist device 13 so that a steering assist force is applied to the steering shaft 11 in accordance with the steering torque detected by the torque sensor 12.

The rack shaft 14 has rack teeth 141, and a pinion gear 111 arranged at the end of the steering shaft 11 engages the rack teeth 141 in the rack housing 15. When the steering shaft 11 rotates, the meshing of the rack teeth 141 with the pinion gear 111 causes the rack shaft 14 to move in the left-right direction, steering left and right wheels 101, 102.

The rack shaft 14 has left and right ends protruding from the rack housing 15. The boots 181, 182 are made of a flexible material such as rubber or resin to prevent water and other substances from entering the inside of the rack housing 15 through the gap between the rack housing 15 and the rack shaft 14. The left and right boots 181, 182 and the sealing member 183 form the waterproof structure of the rack housing 15. In other words, the rack housing 15 is waterproofed to prevent moisture from entering its inside.

The boots 181, 182 may be partially torn or ripped off, for example, when they come in contact with road surfaces or protrusions on the ground while the vehicle is running. If the vehicle is driven through a deep puddle or the like in such a condition, water can enter the rack housing 15 from the damaged portion of the boots 181, 182. The water that has entered the rack housing 15 may cause rust and may also prevent smooth movement of the rack shaft 14 when it is frozen.

For the above reason, the liquid detection sensor 2 is mounted on the rack housing 15 in the present embodiment. When water ingress is detected by the liquid detection sensor 2, a signal indicating the water ingress into the rack housing 15 is sent to the controller 19, for example, and the driver is notified by a warning light on the instrument panel. The liquid detection sensor 2 is mounted, for example, at the lower end of the rack housing 15 in the vertical direction. The steering device 1 is a detection target device for which the liquid detection sensor 2 detects water ingress into the rack housing 15. Next, the configuration of the liquid detection sensor 2 will be described.

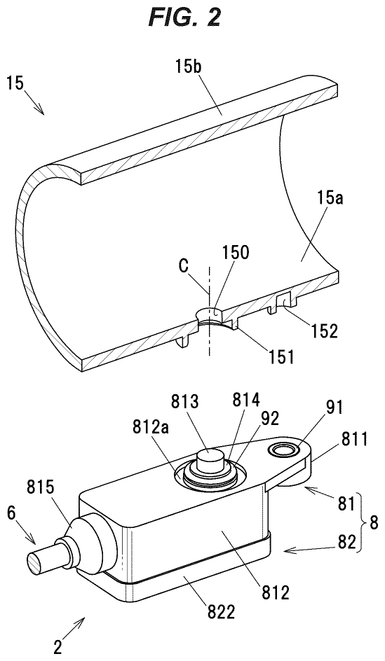

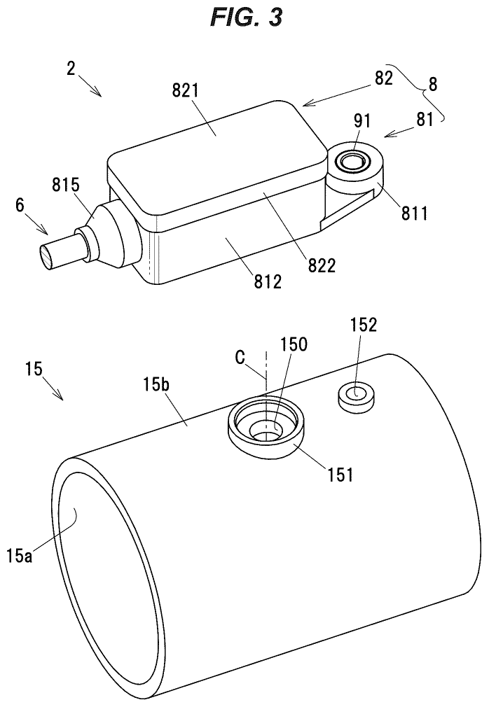

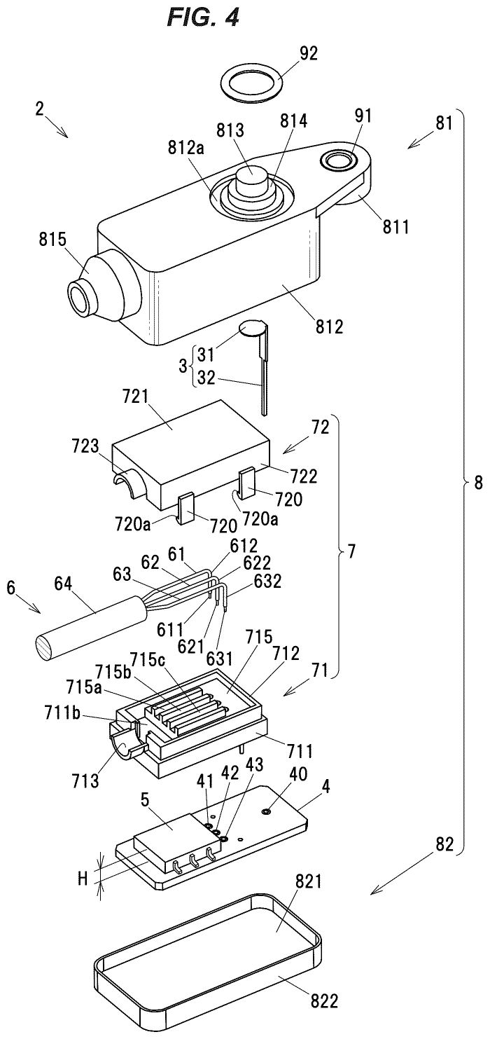

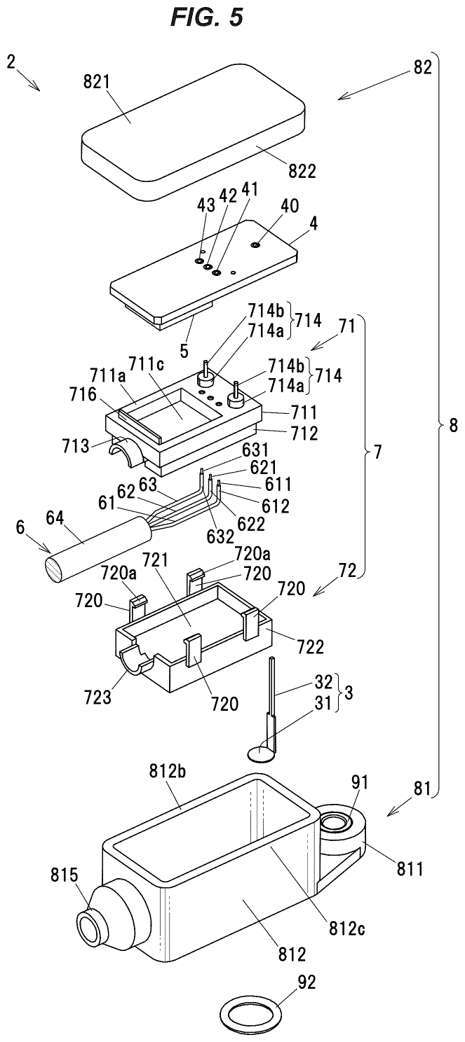

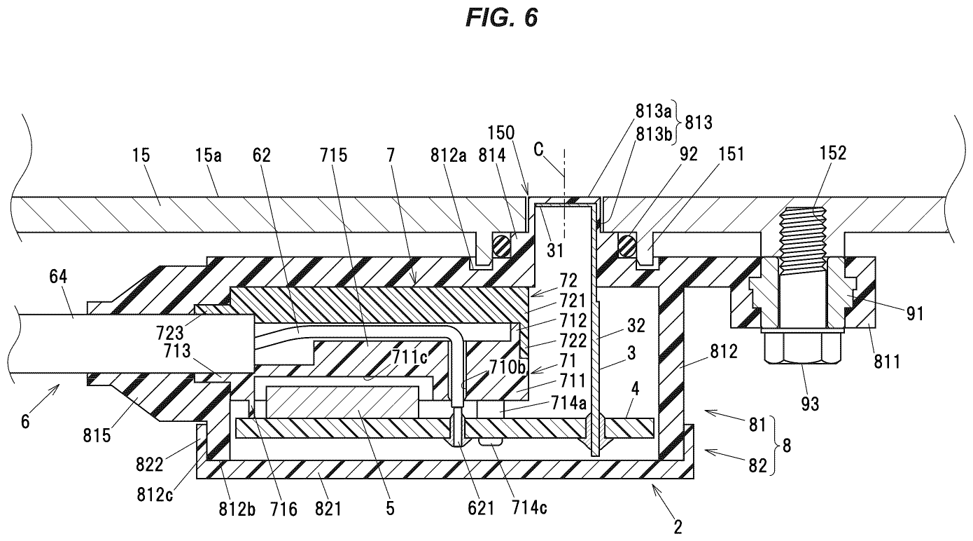

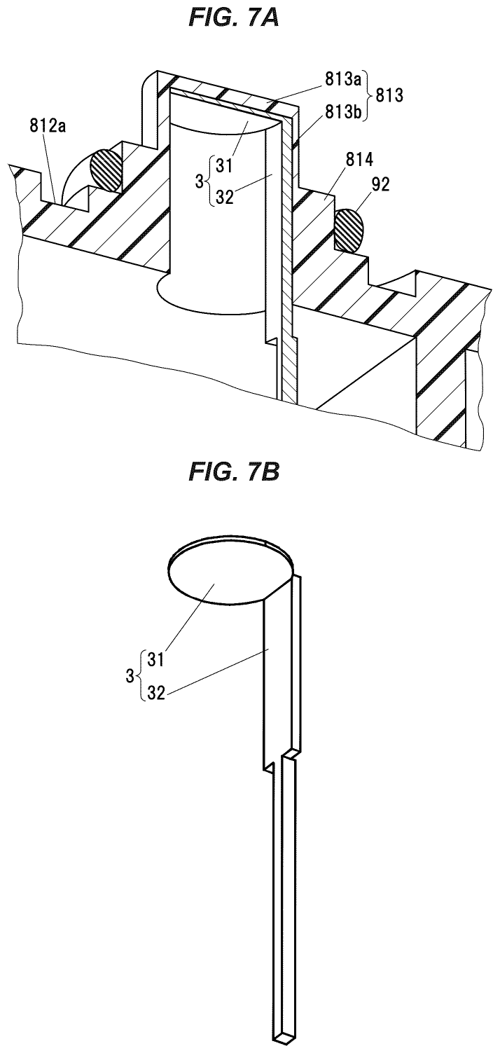

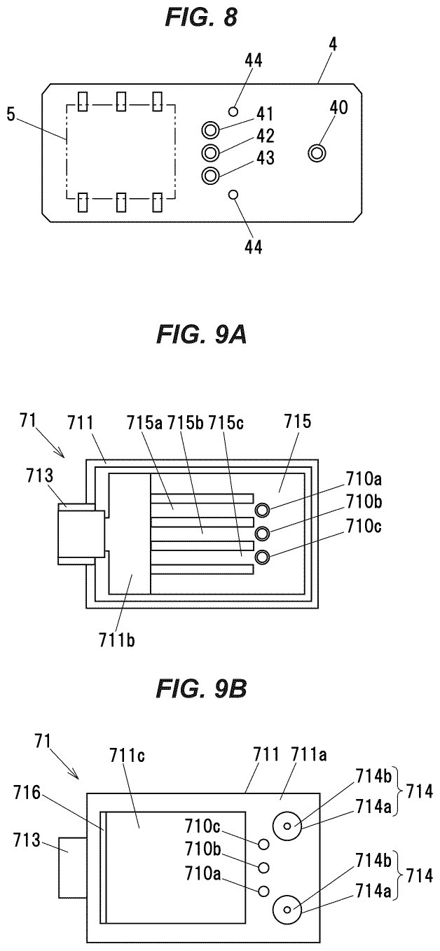

FIG. 2 is a perspective view showing the liquid detection sensor 2 together with a part of the rack housing 15. FIG. 3 is a perspective view of the liquid detection sensor 2 and a part of the rack housing 15, viewed from a different direction from FIG. 1. FIG. 4 is an exploded perspective view of the liquid detection sensor 2, viewed from the same direction as FIG. 2. FIG. 5 is an exploded perspective view of the liquid detection sensor 2, viewed from the same direction as FIG. 3. FIG. 6 is a cross-sectional view of the liquid detection sensor 2 and the rack housing 15. FIG. 7A is a perspective cross-sectional view showing the liquid detection sensor 2 partially enlarged. FIG. 7B is a perspective view showing an electrode member 3 of the liquid detection sensor 2. FIG. 8 is a plane view of a substrate 4 of the liquid detection sensor 2.

The rack housing 15 has, at the location where the liquid detection sensor 2 is mounted, a through-hole 150 that passes between an inner circumferential surface 15a and an outer circumferential surface 15b of the rack housing 15, an annular wall 151 formed protruding from the outer circumferential surface 15b to surround the opening on the outer circumferential surface 15b side of the through-hole 150, and a threaded hole 152. The rack housing 15 is made of metal such as aluminum alloy, and is electrically grounded.

The liquid detection sensor 2 comprises an electrode member 3 having an electrode 31 inserted into the through-hole 150 of the rack housing 15, a substrate 4 to which the electrode member 3 is connected, an electronic component 5 mounted on the substrate 4, a cable 6 having a plurality of electric wires 61, 62, 63 connected to the electrode of the substrate 4 and a sheath 64, a cable holder 7 holding an end of the cable 6, a sensor case 8 that houses the substrate 4 and electrode member 3 together with the cable holder 7, a collar 91 embedded in the sensor case 8, and an O-ring 92 attached to the sensor case 8. The liquid detection sensor 2 detects liquid ingress into the rack housing 15 by the change in electrostatic capacitance between the electrode 31 and the rack housing 15 due to water or other liquid that has entered the rack housing 15.

The electrode member 3 is made of copper or a copper alloy, for example, and has in one piece, a flat electrode 31 and a connecting line portion 32 that connects the electrode 31 to the substrate 4. The electrode 31 is formed at a right angle to the longitudinal direction of the connecting line portion 32. The connecting line portion 32 is connected to the through-hole land 40, which is a substrate electrode of the substrate 4, for example, by soldering. The electrode 31 is placed in the through-hole 150 without entering inside the rack housing 15 beyond the inner circumferential surface 15a, which is the inner surface of the rack housing 15. In other words, the length of the connecting line portion 32 is set shorter than the distance between the substrate 4 and the inner circumferential surface 15a of the rack housing 15. This prevents the liquid detection sensor 2 from interfering with the rack shaft 14.

The shape of the through-hole 150 and the shape of the electrode 31 are both circular, viewed from the axial direction of the through-hole 150 (radial direction of the rack housing 15). The central axis C of the through-hole 150 coincides with the center of the electrode 31. The electrode 31 is placed in the through-hole 150, accommodated in the sensor case 8.

In the present embodiment, the substrate 4 is a rigid substrate having a plate-like base material made of a dielectric such as FR4 (glass fiber soaked with epoxy resin and thermoset), but not limited to this, it may be a flexible substrate with a flexible film-like dielectric such as polyimide as a base material. On the surface of the substrate 4, wiring pattern made of copper foil is formed to connect the electronic component 5 to the plurality of electric wires 61, 62, 63 of the cable 6 and the electrode member 3, but the wiring pattern is omitted in each drawing. The electronic component 5 detects the electrostatic capacitance between the electrode 31 and the rack housing 15. The circuit configuration in the electronic component 5 is described below.

The electric wires 61, 62, 63 of the cable 6 are insulated coated wires in which metal core wires 611, 621, 631 are covered by insulating coatings 612, 622, 632 that are made of insulating material. For example, the wires 61, 62 of the three wires 61, 62, 63 are used to supply power to the electronic component 5 and the wire 63 is used to transmit output signals from the electronic component 5. The core wires 611, 621, and 631 of the electric wires 61, 62, 63 are respectively connected to through-hole lands 41, 42, 43 that are substrate electrodes mounted on the substrate 4, for example, by soldering. The sheath 64 is, for example, a urethane sheath made of urethane, which covers the three electric wires 61, 62, 63 collectively.

The cable holder 7 comprises a first member 71 and a second member 72 that are made of resin, and accommodates a part in the longitudinal direction of each of the electric wires 61, 62, 63 derived from the sheath 64. The first member 71 and the second member 72 have rectangular-shaped bottom plates 711, 721, peripheral wall portions 712, 722 formed along the outer edge of the bottom plates 711, 721, and semi-cylindrical sheath holding portions 713, 723 that hold the sheath 64, respectively.

The outer surface 711a (see FIG. 5) of the bottom plate 711 of the first member 71 faces in parallel to the substrate 4. The sheath holding portions 713 and 723 make a cylindrical shape when the first member 71 and the second member 72 are combined so as to hold the sheath 64. The first member 71 and the second member 72 are combined by a snap-fit structure. More specifically, claw portions 720a at the tip of a plurality of snap-fit pieces 720 provided in the second member 72 are fastened to the bottom plate 711 of the first member 71.

FIG. 9A is a configuration diagram showing the inside of the first member 71, and FIG. 9B is a configuration diagram showing the outside of the first member 71. The first member 71 comprises a pair of positioning projections 714 provided to protrude from the outer surface 711a of the bottom plate 711 toward the substrate 4, a wire holding portion 715 provided to protrude from the inner surface 711b of the bottom plate 711 toward the second member 72, and a wall-shaped projection 716 contacting the substrate 4.

Each of the positioning projections 714 comprises a large-diameter cylindrical portion 714a and a small-diameter cylindrical portion 714b, and the large-diameter cylindrical portion 714a and the small-diameter cylindrical portion 714b are provided on the same axis. The large-diameter cylindrical portion 714a contacts the surface of the first member 71 side of the substrate 4, and the distance between the substrate 4 and the bottom plate 711 of the first member 71 is defined by the large-diameter cylindrical portion 714a and the projection 716. The substrate 4 has an insertion hole 44 through which the small-diameter cylindrical portion 714b is inserted. When the small-diameter cylindrical portion 714b inserted into the insertion hole 44 is crushed toward the substrate 4 while being heated, a detent 714c of the substrate 4 is formed as shown in FIG. 6.

The wire holding portion 715 has retaining grooves 715a, 715b, and 715c that accommodate the electric wires 61, 62, 63 respectively, and the electric wires 61, 62, 63 are prevented from slipping out of the retaining grooves 715a, 715b, and 715c by the bottom plate 721 of the second member 72. The bottom plate 711 and the wire holding portion 715 have exit holes 710a, 710b, and 710c for guiding the respective tips of the electric wires 61, 62, 63 toward the substrate 4. The electric wires 61, 62, 63 are bent 900 in the cable holder 7, and led out through the exit holes 710a, 710b, and 710c. Then their tips protruding from the cable holder 7 are connected to the through-hole lands 41, 42, 43 of the substrate 4.

The bottom plate 711 has a recess 711c, which is recessed from the outer surface 711a to accommodate a part of the electronic component 5. In other words, the height H of the electronic component 5 (see FIG. 4) is higher than the thickness of the large-diameter cylindrical portion 714a of the positioning projection 714, and accommodating the electronic component 5 in the recess 711c allows the liquid detection sensor 2 to be downsized.

The sensor case 8 consists of a case body 81 and a case lid 82. The case body 81 and the case lid 82 are made of injection molding resin. A metal collar 91 and the electrode member 3 are insert molded into the case body 81. The case body 81 has, in one piece, a mounting portion 811 into which the collar 91 is insert molded, an accommodating portion 812 that accommodates the substrate 4 and the cable holder 7, an electrode holding portion 813 that holds the electrode 31 of the electrode member 3, a seal retaining portion 814 into which the O-ring 92 as a seal member is fitted, and a leading portion 815 that leads out the cable 6.

As shown in FIG. 6, the sensor case 8 is attached to the rack housing 15 by screwing a bolt 93 inserted into the collar 91 into a threaded hole 152 of the rack housing 15. The accommodating portion 812 has an annular groove 812a that accommodates the tip of the annular wall 151 of the rack housing 15. The electrode holding portion 813 is a bottomed cylinder, having a bottom portion 813a and a cylindrical portion 813b, and the electrode 31 is embedded in the bottom portion 813a. A part of the connecting line portion 32 is embedded in the cylindrical portion 813b.

A seal retaining portion 814 is provided around the periphery of the electrode holding portion 813, and the O-ring 92 is fitted externally to the seal retaining portion 814. The leading portion 815 is welded to the sheath 64 of the cable 6, which prevents moisture from entering the accommodating portion 812 through the leading portion 815. As the material of the case body 81, a resin that easily melds with the sheath 64 is preferable, for example, urethane. Also, polyamide (PA) such as nylon resin or polybutylene phthalate (PBT) can be used as the material of the case body 81.

In the present embodiment, the tip of the electrode holding portion 813 is placed in the through-hole 150 without protruding inside the rack housing 15 from the inner circumferential surface 15a of the rack housing 15. This prevents the electrode holding portion 813 from interfering with the rack shaft 14. However, the tip of the electrode holding portion 813 may protrude inside the rack housing 15 from the inner circumferential surface 15a of the rack housing 15 as long as it does not interfere with the movement of the rack shaft 14.

The case lid 82 has, in one body, a flat plate portion 821 that is butted against a tip surface 812b of the accommodating portion 812 in the case body 81, and a surrounding wall portion 822 that surrounds the outer circumference surface 812c near the 812b in the accommodating portion 812. The accommodating portion 812 of the case body 81 and the surrounding wall portion 822 of the case lid 82 are welded over the entire circumference, for example, by laser welding or ultrasonic welding. The case lid 82 may also be bonded to the case body 81. The case lid 82 prevents foreign matter such as moisture from entering the accommodating portion 812. When the accommodating portion 812 of the case body 81 and the surrounding wall portion 822 of the case lid 82 are welded by laser welding or ultrasonic welding, it is preferable that the case lid 82 be made of the same material as the case body 81. However, the case lid 82 may be made of a different material from the case body 81.

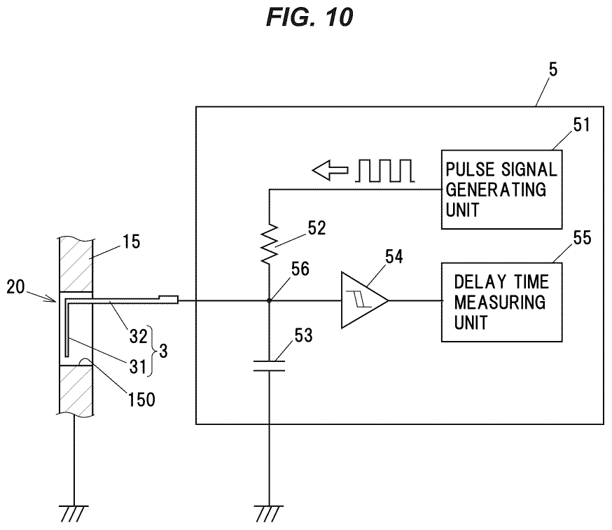

FIG. 10 is a circuit diagram showing a configuration example of an electrostatic capacitance measurement circuit in the electronic component 5. This example of circuit configuration is also used, for example, in a touch sensor that detects human finger contact, and has a pulse signal generating unit 51, a resistor 52, a capacitor 53, a gate element 54, a delay time measuring unit 55. The resistor 52 and the capacitor 53 are connected in series between the pulse signal generating unit 51 and a ground potential. The gate element 54 is connected to a node 56, which is located between the resistor 52 and the capacitor 53, and the delay time measuring unit 55. The node 56 is connected to the connecting line portion 32 of the electrode member 3.

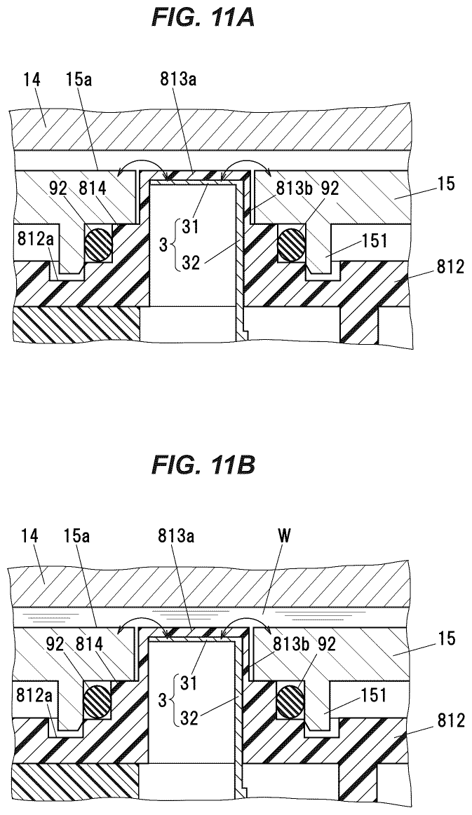

FIG. 11A is a cross-sectional view of the periphery of the electrode 31 when there is no water ingress into the rack housing 15. FIG. 11B is a cross-sectional view of the periphery of the electrode 31 when ingress water W has entered the rack housing 15 and accumulated in the periphery of the electrode 31. Electrostatic capacitance is generated between the electrode 31 and the rack housing 15, and the magnitude of the electrostatic capacitance varies depending on the presence or absence of the ingress water W. This is because the relative permittivity of air is about 1.0, while that of water is about 80.0. In FIG. 11A and FIG. 11B, the strength of the capacitive coupling between the electrode 31 and the rack housing 15 is schematically represented by the difference in thickness of both arrows.

The pulse signal generating unit 51 of the electronic component 5 outputs a pulse signal at a predetermined period, which is transmitted through the resistor 52 to the node 56. The electrode 31 and the rack housing 15 constitute a capacitance 20 in parallel to the capacitor 53. When the electrostatic capacitance in the capacitance 20 changes, the combined electrostatic capacitance of the capacitance 20 and the capacitor 53 changes, which changes the delay time of the voltage input via the gate element 54 to the delay time measuring unit 55. By measuring the change in delay time with the delay time measuring unit 55, the electronic component 5 can detect the electrostatic capacitance of capacitance 20, i.e., the electrostatic capacitance between the electrode 31 and the rack housing 15, and thus, water ingress into the rack housing 15 can be detected.

Next, a manufacturing method of the liquid detection sensor 2 will be described. The liquid detection sensor 2 is manufactured by the following steps 1 through 7. Step 1: Remove a part of the sheath 64 of the cable 6 over a predetermined length to expose the electric wires 61, 62, 63, and then perform terminal processing by removing the insulation coverings 612, 622, and 632 at the ends of wires 61, 62, 63 to expose the core wires 611, 621, and 631.

Step 2: Insert the electric wires 61, 62, 63 of the cable 6 that have been terminal processed into the exit holes 710a, 710b, and 710c of the first member 71 of the cable holder 7, and make the electric wires 61, 62, 63 held in the retaining grooves 715a, 715b, and 715c of the wire holding portion 715.

Step 3: Combine the first member 71 and the second member 72 of the cable holder 7.

Step 4: Place a part of the cable 6, the cable holder 7, the electrode member 3, and the collar 91 in a mold, and inject molten resin into the mold to form the case body 81, so as to obtain the case body 81 in which the cable 6, cable holder 7, the electrode member 3, and the collar 91 are insert molded.

Step 5: Position and secure the substrate 4 to the cable holder 7 in the case body 81.

Step 6: Connect the tips of the electric wires 61, 62, 63 derived from the cable holder 7 to the through-hole lands 41, 42, 43 of the substrate 4 on which the electronic component 5 is mounted, and connect the connecting line portion 32 of the electrode member 3 to the through-hole land 40 of the substrate 4.

Step 7: Combine the case body 81 and the case lid 82, and attach the O-ring 92 to the seal retaining portion 814 of the case body 81.

These steps 1 through 7 are shown as an example, and the liquid detection sensor 2 may be manufactured by other procedures as long as the liquid detection sensor 2 according to the present embodiment can be finally obtained.

### Advantageous Effects of the Embodiment

According to the embodiment described above, when water enters the rack housing 15, for example, from a damaged portion of the boots 181, 182, and a certain amount of ingress water W has accumulated around the electrode 31, the water ingress can be detected with a high degree of reliability.

### SUMMARY OF THE EMBODIMENT

Next, the technical concepts that can be grasped from the embodiments described above will be described with reference to the reference numerals and the like used in the embodiments. However, each reference numeral in the following description does not limit the constituent elements in the scope of the claims to the members and the like specifically shown in the embodiment.

According to the first feature, a liquid detection sensor 2 for detecting liquid ingress into a housing (a rack housing) 15 of a detection target device (a steering device) 1 in which the housing 15 is waterproofed, includes an electrode 31 configured to be inserted into a through-hole formed in the housing 15, wherein the liquid ingress into the housing 15 is detected by a change in electrostatic capacitance of the electrode 31.

According to the second feature, in the liquid detection sensor 2 as described by the first feature, the housing 15 is electrically grounded, and the liquid ingress into the housing 15 is detected by a change in the electrostatic capacitance between the electrode 31 and the housing 15.

According to the third feature, in the liquid detection sensor 2 as described by the second feature, the electrode 31 is positioned in a through-hole 150 without entering inside beyond an inner surface 15a of the housing 15.

According to the fourth feature, the liquid detection sensor 2 as described by the first feature further includes an electronic component 5 that detects an electrostatic capacitance between the electrode 31 and the housing 15, a substrate 4 on which the electronic component 5 is mounted, and an electrode member 3 having the electrode 31, wherein the electrode member 3 has a connecting line portion 32 which connects the electrode 31 and the substrate 4.

According to the fifth feature, the liquid detection sensor 2 as described by the fourth feature further includes a cable 6 having a plurality of electric wires 61, 62, 63 connected to substrate electrodes (through-hole lands) 41, 42, 43 formed on the substrate 4 and a sheath 64 collectively covering the plurality of electric wires 61, 62, 63, and a sensor case 8 housing the substrate 4 and the electrode member 3, wherein the sheath 64 is welded to the sensor case 8.

According to the sixth feature, the liquid detection sensor 2 as described by the fifth feature further includes a cable holder 7 accommodating a part in a longitudinal direction of each of the plurality of electric wires 61, 62, 63 derived from the sheath 64, wherein tips of the plurality of electric wires 61, 62, 63 derived from the cable holder 7 are connected to the substrate electrodes 41, 42, 43 respectively.

According to the seventh feature, in the liquid detection sensor 2 as described by the sixth feature, a recess 711c is formed in the cable holder 7 to accommodate the electronic component 5.

According to the eighth feature, in the liquid detection sensor 2 as described by any one of the first to seventh features, the detection target device 1 is a vehicle steering device and the housing 15 is a rack housing that accommodates a rack shaft 14.

The above description of the embodiments according to the present invention does not limit the invention to the scope of the claims. It should also be noted that not all of the combinations of features described in the embodiments are essential to the means for solving the problems of the invention. In addition, the invention can be implemented by modifying it as appropriate to the extent that it does not depart from the intent of the invention. For example, it can be implemented by modifying it as follows.

The embodiment above describes the case where the electrode 31 of the electrode member 3 has a circular flat plate shape, but not limited to this, the shape of the electrode can be, for example, a cylindrical shape parallel to the inner surface of the through-hole 150 of the rack housing 15. In this case, the electrostatic capacitance is changed by ingress water that has entered between the electrode and the through-hole 150, so water ingress can be detected by this change in capacitance. Also, multiple electrodes may be provided in the liquid detection sensor. The electrodes may be formed on the substrate of the liquid detection sensor by leaving copper foil, and the electrodes on the substrate may be inserted into the through-hole 150.

Although the above embodiment describes a case of detecting the ingress of water into the rack housing 15 of the vehicle steering device 1 by means of the liquid detection sensor 2, the liquid detection sensor of the present invention may be used to detect the ingress of water or other liquids into a detection target device other than the steering device 1. Furthermore, the liquid to be detected by the liquid detection sensor of the present invention is not limited to water, but the liquid detection sensor of the present invention can be used to detect the ingress of various liquids into the housing.

1. A liquid detection sensor for detecting liquid ingress into a housing of a detection target device in which the housing is waterproofed, comprising:
an electrode configured to be inserted into a through-hole formed in the housing,
wherein the liquid ingress into the housing is detected by a change in electrostatic capacitance of the electrode.

2. The liquid detection sensor according to claim 1, wherein the housing is electrically grounded and wherein the liquid ingress into the housing is detected by a change in electrostatic capacitance between the electrode and the housing.

3. The liquid detection sensor according to claim 2, wherein the electrode is placed in the through-hole without entering inside beyond an inner surface of the housing.

4. The liquid detection sensor according to claim 1, further comprising:
an electronic component that detects electrostatic capacitance between the electrode and the housing;
a substrate on which the electronic component is mounted; and
an electrode member having the electrode,
wherein the electrode member has a connecting line portion that connects the electrode to the substrate.

5. The liquid detection sensor according to claim 4, further comprising:
a cable having a plurality of electric wires connected to substrate electrodes formed on the substrate and a sheath collectively covering the plurality of electric wires; and
a sensor case that houses the substrate and the electrode member,
wherein the sheath is welded to the sensor case.

6. The liquid detection sensor according to claim 5, further comprising:
a cable holder that accommodates a part in a longitudinal direction of each of the plurality of electric wires derived from the sheath,
wherein tips of the plurality of electric wires protruding from the cable holder are connected to the substrate electrodes respectively.

7. The liquid detection sensor according to claim 6, wherein a recess is formed in the cable holder to accommodate the electronic component.

8. The liquid detection sensor according to claim 1, wherein the detection target device is a vehicle steering device, and wherein the housing is a rack housing that houses a rack shaft.
